(19) United States
(12) Patent Application Publication
(10) Pub. No.: US 2025/0350152 A1
(43) Pub. Date: Nov. 13, 2025

(54) CONTACTLESS ELECTRIC POWER TRANSMISSION SYSTEM

(71) Applicant: HONDA MOTOR CO., LTD., Tokyo (JP)

(72) Inventors: Jin Katsuya, Wako-shi (JP); Shuji Kawano, Wako-shi (JP); Kenichiro Takahashi, Wako-shi (JP)

(21) Appl. No.: 19/199,425

(22) Filed: May 6, 2025

(30) Foreign Application Priority Data
May 13, 2024 (JP) 2024-078247

(51) Int. Cl. H02J 50/12; B60L 53/122; B60L 53/62

(52) U.S. Cl. CPC H02J 50/12; B60L 53/122; B60L 53/62

(57) ABSTRACT

A contactless electric power transmission system includes an electric power transmission portion, a transmission electric power conversion portion, and an electric power transmission side control device. The electric power transmission portion includes a primary side coil that transmits AC electric power that is transmitted to an electric power reception device in a contactless manner. The transmission electric power conversion portion includes a plurality of transistors that are connected to the primary side coil. The transmission electric power conversion portion converts DC electric power supplied from an electric power source portion into AC electric power. The electric power transmission side control device changes transmission electric power in a decreasing tendency in accordance with a time elapse until electric power transmission stoppage at the time of electric power transmission by the electric power source portion.

### CROSS-REFERENCE TO RELATED APPLICATION

Priority is claimed on Japanese Patent Application No. 2024-078247, filed on May 13, 2024, the contents of which are incorporated herein by reference.

### BACKGROUND

### Field of the Invention

The present invention relates to a contactless electric power transmission system.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a contactless electric power transmission system that supplies electric power from an electric power transmission side to an electric power reception side by contactless electric power transmission, a system is known in which supply electric power in accordance with request electric power on the electric power reception side is transmitted from the electric power transmission side to the electric power reception side based on information transmitted from the electric power reception side to the electric power transmission side (for example, refer to Japanese Unexamined Patent Application, First Publication No. 2015-136274 and PCT International Publication No. 2020/049853).

### SUMMARY

In techniques relating to charging and electric power supply in a vehicle on which a secondary battery is mounted, in contactless electric power transmission to a vehicle during traveling or during stopping, it is desired to perform appropriate electric power transmission in accordance with an electric power request on the vehicle side. For example, when a rapid increase of supply electric power occurs when a coil on the electric power reception side approaches or leaves a coil on the electric power transmission side, there is a possibility that a failure occurs such as an increase of a load due to a frequency decrease or the like in a system electric power source on the electric power transmission side and an electric power supply stoppage caused by overcurrent detection due to hunting of a current.

An aspect of the present invention aims at providing a contactless electric power transmission system capable of performing appropriate electric power transmission to a movable body during moving and during stopping. Further, the aspect of the present invention contributes to energy efficiency.

A contactless electric power transmission system according to a first aspect of the present invention includes: an electric power transmission side coil that transmits electric power to an electric power reception side coil in a contactless manner; an electric power transmission side electric power conversion portion that is connected to the electric power transmission side coil and converts electric power supplied from an electric power source; and an electric power transmission side control device that controls an operation of the electric power transmission side electric power conversion portion, wherein the electric power transmission side control device changes transmission electric power in a decreasing tendency in accordance with a time elapse until electric power transmission stoppage at a time of electric power transmission by the electric power transmission side coil.

A second aspect is the contactless electric power transmission system according to the first aspect described above, wherein the electric power transmission side control device may change the transmission electric power in the decreasing tendency when a coupling degree between the electric power transmission side coil and the electric power reception side coil is less than a predetermined degree or when an electric power transmission duration time by the electric power transmission side coil is equal to or more than a predetermined time at the time of the electric power transmission by the electric power transmission side coil.

A third aspect is the contactless electric power transmission system according to the second aspect described above which may include: a current sensor that detects a current which flows through the electric power transmission side coil, wherein the electric power transmission side control device may acquire the coupling degree based on the detection value of the current output from the current sensor.

A fourth aspect is the contactless electric power transmission system according to the second aspect described above, wherein the electric power transmission side control device may shift the electric power transmission side electric power conversion portion to a reception standby state in which information relating to the electric power transmission is received from the electric power reception side coil after the electric power transmission stoppage when the electric power transmission duration time reaches the predetermined time or more.

A fifth aspect is the contactless electric power transmission system according to any one of the first to fourth aspects described above, wherein the electric power transmission side electric power conversion portion may include a plurality of switching elements that are connected to the electric power transmission side coil, and the electric power transmission side control device may control the transmission electric power by the duty ratio or the phase shift amount of a signal that commands an operation of the plurality of switching elements.

A sixth aspect is the contactless electric power transmission system according to the fourth aspect described above which may include: the electric power reception side coil; an electric power reception side electric power conversion portion that is connected to the electric power reception side coil; and an electric power reception side control device that controls an operation of the electric power reception side electric power conversion portion, wherein the electric power reception side control device may shift the electric power reception side electric power conversion portion to a transmission state in which the information relating to the electric power transmission is transmitted from the electric power reception side coil to the electric power transmission side coil when an electric power reception duration time reaches a predetermined time or more at a time of electric power reception by the electric power reception side coil, and may shift the electric power reception side electric power conversion portion from the transmission state to an electric power reception standby state of electric power after the information relating to the electric power transmission is transmitted.

According to the first aspect described above, since the electric power transmission side control device changes the transmission electric power in the decreasing tendency in accordance with the time elapse until the electric power transmission stoppage, it is possible to prevent an increase of a load of an electric power source and the occurrence of an overcurrent. For example, it is possible to prevent the occurrence of a failure such as an increase of a load due to a frequency decrease or the like in a system electric power source on the electric power transmission side and an electric power supply stoppage caused by overcurrent detection due to hunting of a current.

In the case of the second aspect described above, by changing the transmission electric power in the decreasing tendency when the coupling degree is less than the predetermined degree or when the electric power transmission duration time is equal to or more than the predetermined time, the electric power transmission side control device can prevent an electric power loss from increasing or prevent an overcharge on the electric power reception side from occurring. It is possible to perform appropriate electric power transmission in accordance with a request to a movable body during moving or during stopping.

In the case of the third aspect described above, since the electric power transmission side control device controls the electric power transmission by the coupling degree acquired based on the current detected on the electric power transmission side, it is possible to perform appropriate electric power transmission, for example, to each of movable bodies such as a plurality of vehicles having different request electric power.

In the case of the fourth aspect described above, the electric power transmission side control device can acquire the information relating to the electric power transmission newly at each predetermined time and, for example, can perform appropriate electric power transmission in accordance with a request on the electric power reception side while preventing the occurrence of a failure such as an overcharge on the electric power reception side.

In the case of the fifth aspect described above, since the electric power transmission side control device controls the transmission electric power by the duty ratio or the phase shift amount, it is possible to quickly control the transmission electric power even when an electric power reception device moves relative to an electric power transmission device.

In the case of the sixth aspect described above, the electric power reception side control device can transmit the information relating to the electric power transmission newly at each predetermined time and, for example, can receive appropriate electric power in accordance with a request on the electric power reception side while preventing the occurrence of a failure such as an overcharge on the electric power reception side.

### BRIEF DESCRIPTION OF THE DRAWINGS

FIG. 1 is a view showing an example configuration of a contactless electric power transmission system in an embodiment of the present invention.

FIG. 2 is a view showing an example configuration of the contactless electric power transmission system in the embodiment of the present invention.

FIG. 3 is a view showing details of a configuration of the contactless electric power transmission system in the embodiment of the present invention.

FIG. 4 is a view showing a configuration of an electric power transmission portion and an electric power reception portion of the contactless electric power transmission system in the embodiment of the present invention.

FIG. 5 is a view showing a T-type equivalent circuit in the contactless electric power transmission system of the embodiment of the present invention.

FIG. 6 is a flowchart showing an electric power reception side process of the contactless electric power transmission system in the embodiment of the present invention.

FIG. 7 is a flowchart showing an electric power transmission side process of the contactless electric power transmission system in the embodiment of the present invention.

FIG. 8 is a flowchart showing an electric power transmission control shown in FIG. 7.

FIG. 9 is a view showing an example of changes of an electric power transmission side voltage and an electric power transmission side current in a ramp-up control of the contactless electric power transmission system of the embodiment of the present invention.

FIG. 10 is a view showing an example of changes of the electric power transmission side voltage and the electric power transmission side current in a ramp-down control of the contactless electric power transmission system of the embodiment of the present invention.

FIG. 11 is a view showing an example of a correspondence relationship between an electric power transmission side output and a coupling coefficient in the contactless electric power transmission system of the embodiment of the present invention.

### DESCRIPTION OF EMBODIMENTS

Hereinafter, a contactless electric power transmission system according to an embodiment of the present invention will be described with reference to the drawings.

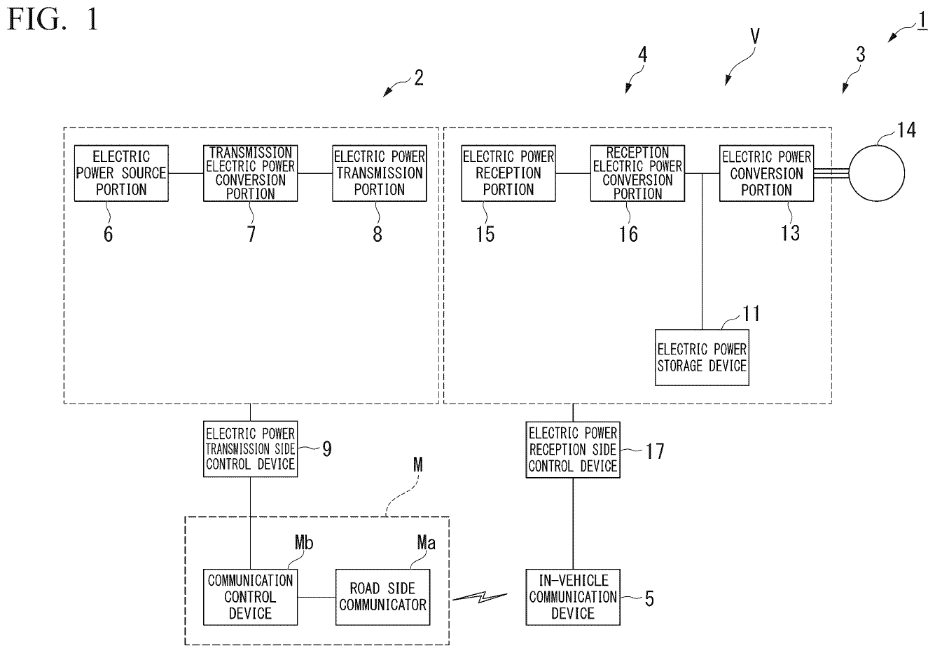

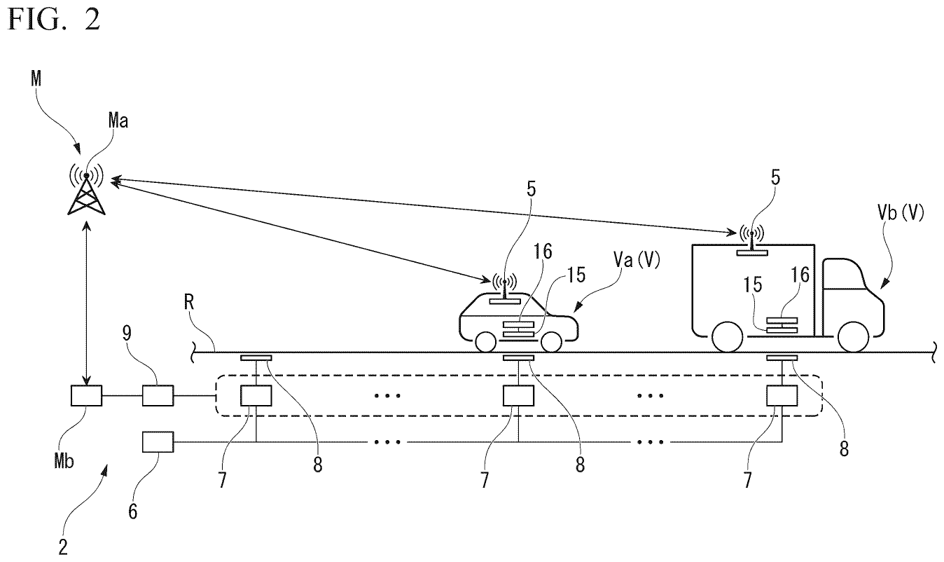

FIG. 1 and FIG. 2 are views showing an example configuration of a contactless electric power transmission system 1 of an embodiment.

The contactless electric power transmission system 1 of the embodiment supplies electric power, for example, from the outside (a movement path or the like) of a movable body to the movable body by contactless electric power transmission. The movable body is, for example, a vehicle V or the like. The vehicle Vis, for example, an electric vehicle such as an electric automobile, a hybrid vehicle, a fuel cell vehicle, and the like. The outside (the movement path or the like) of the movable body is, for example, a travel path R of the vehicle V or the like.

### (Contactless Electric Power Transmission System)

As shown in FIG. 1 and FIG. 2, the contactless electric power transmission system 1 of the embodiment includes, for example, an electric power transmission device 2 provided on a travel path R of the vehicle V, a drive control device 3 mounted on the vehicle V, an electric power reception device 4, and an in-vehicle communication device 5.

The contactless electric power transmission system 1 of the embodiment may include only at least a configuration element (for example, the electric power transmission device 2) at the outside of the vehicle V, and the contactless electric power transmission may be performed by the combination of configuration elements (for example, the drive control device 3, the electric power reception device 4, and the in-vehicle communication device 5) mounted on the vehicle V and the contactless electric power transmission system 1 at the outside of the vehicle V. Further, the contactless electric power transmission system 1 of the embodiment may include only at least the configuration elements (for example, the drive control device 3, the electric power reception device 4, and the in-vehicle communication device 5) mounted on the vehicle V, and the contactless electric power transmission may be performed by the combination of the configuration element (for example, the electric power transmission device 2) at the outside of the vehicle V and the contactless electric power transmission system 1 mounted on the vehicle V.

The electric power transmission device 2 includes, for example, a communication system M that constitutes an electric power transmission side communication device, an electric power source portion 6 (electric power source), at least one set (for example, a plurality of sets) of a transmission electric power conversion portion 7 (electric power transmission side electric power conversion portion) and an electric power transmission portion 8, and an electric power transmission side control device 9.

The communication system M wirelessly communicates with the in-vehicle communication device 5 that constitutes an electric power reception side communication device mounted on the vehicle V. The communication system M constitutes, for example, at least a part of a system that electronically collects a toll such as an ETC (Electronic Toll Collection System) on a toll road, a system that performs exchange of road traffic information and various information for drive assist, and the like.

The communication system M includes, for example, one or more roadside communicators Ma that wirelessly communicates with the in-vehicle communication device 5 of the vehicle V by a so-called road-to-vehicle communication and a communication control device Mb. Each of the one or more roadside communicators Ma and the communication control device Mb are connected to each other, for example, via a wired or wireless communication network. The communication network includes, for example, the Internet, a mobile communication network, a LAN (Local Area Network), a WAN (Wide Area Network), and the like.

The roadside communicator Ma is arranged, for example, on the travel path R of the vehicle V on an upstream side of a coupling zone (a communication zone and an electric power transmission zone) described later to be separated by a predetermined distance from the coupling zone. The roadside communicator Ma includes various communication devices such as an antenna for wireless communication.

The communication control device Mb controls operations of all roadside communicators Ma that are associated with the communication control device Mb in advance. The communication control device Mb is, for example, a software function unit that functions by a predetermined program being executed by a processor such as a CPU (Central Processing Unit). The software function unit is an ECU that includes the processor such as a CPU, a ROM (Read Only Memory) that stores the program, a RAM (Random Access Memory) that temporarily stores data, and an electronic circuit such as a timer. At least part of the communication control device Mb may be an integrated circuit such as a LSI (Large Scale Integration).

The communication system M and the in-vehicle communication device 5 correspond to, for example, a primary authentication device and a secondary authentication device and exchange at least authentication information exclusively assigned to each vehicle V. The communication system M and the in-vehicle communication device 5 attempt to transmit and receive first information, for example, by wireless communication between the roadside communicator Ma and the in-vehicle communication device 5 of a surrounding vehicle V at a predetermined cycle or the like.

For example, the first information transmitted from the in-vehicle communication device 5 to the communication system M includes at least information relating to electric power transmission. The information relating to the electric power transmission includes, for example, information of an electric power transmission request such as a request electric power and a request frequency with respect to the electric power transmission from the electric power transmission device 2 to the vehicle V, information required for charging and settlement with respect to the electric power transmission, and the like. The information required for charging and settlement is, for example, information unique to the vehicle V such as the presence or absence of an IC card for toll collection, an in-vehicle transponder, or the like, and an identifier.

For example, the first information transmitted from the communication system M to the in-vehicle communication device 5 includes at least key information, information relating to installation of the electric power transmission device 2, and the like. The key information is, for example, information generated while being updated at a predetermined cycle so as to be different for each approved vehicle V (that is, a vehicle V permitted to perform electric power transmission) that passes through a predetermined electric power transmission zone described later. The key information is information required for the electric power transmission device 2 to authenticate the electric power reception device 4 of the vehicle V and to start the electric power transmission. The information relating to the installation of the electric power transmission device 2 is, for example, information of an installation interval of a plurality of electric power transmission portions 8 described later, the distance from the roadside communicator Ma, and the like.

For example, when the communication system M acquires the information required for charging and settlement of electric power transmission from the in-vehicle communication device 5, the communication system M confirms whether or not electronic settlement is possible. When the communication system M confirms that the electronic settlement is possible, the communication system M transmits permission information indicating permission of the electric power transmission and key information required for starting the electric power transmission to the in-vehicle communication device 5. When the communication system M transmits the key information to the in-vehicle communication device 5, the communication system M transmits the information of a combination of the same key information and the information relating to the electric power transmission received from the in-vehicle communication device 5 to the electric power transmission side control device 9 described later.

The electric power source portion 6 is connected to, for example, a plurality of transmission electric power conversion portions 7. The electric power source portion 6 includes, for example, an AC electric power source such as a commercial electric power source, an AC-DC converter that converts AC electric power into DC electric power, and a capacitor for smoothing electric power. The electric power source portion 6 converts AC electric power supplied from the AC electric power source into DC electric power by the AC-DC converter.

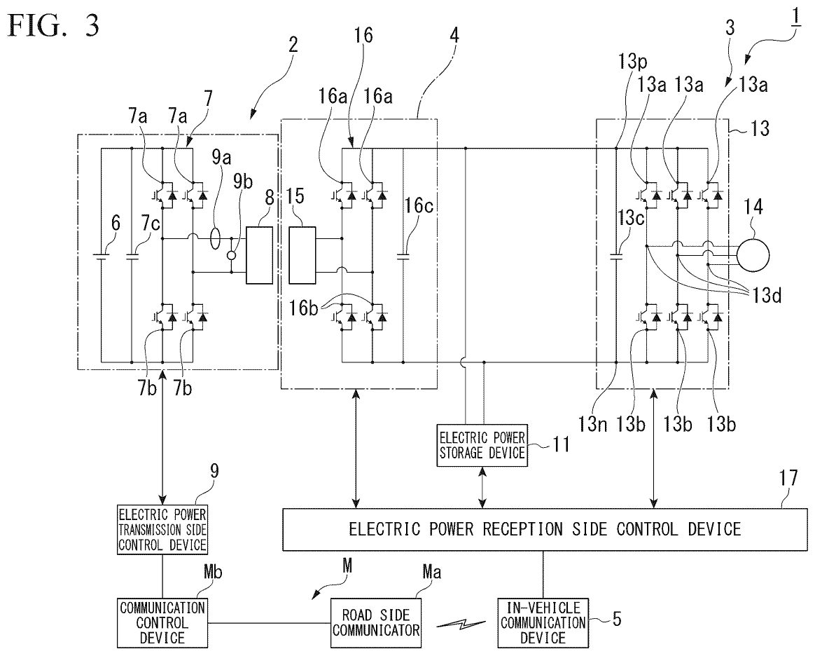

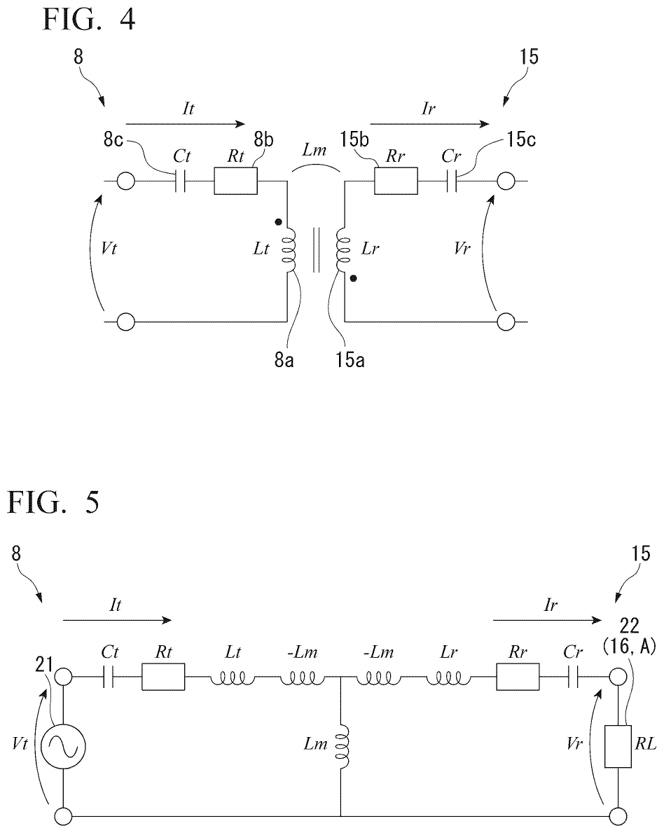

FIG. 3 is a view showing details of a configuration of the contactless electric power transmission system 1 in the embodiment. FIG. 4 is a view showing a configuration of the electric power transmission portion 8 and an electric power reception portion 15 of the contactless electric power transmission system 1 in the embodiment.

As shown in FIG. 3, the transmission electric power conversion portion 7 includes, for example, an inverter that converts DC electric power into AC electric power. The inverter of the transmission electric power conversion portion 7 includes, for example: a first bridge circuit formed of a plurality of switching elements connected in two phases by bridge connection and a rectifier element; and a capacitor. Each switching element is, for example, a transistor such as a SiC (Silicon Carbide) MOSFET (Metal Oxide Semiconductor Field Effect Transistor). The plurality of switching elements are high-side arm and low-side arm transistors 7a, 7b that form a pair in each phase. The rectifier element is, for example, a reflux diode connected in parallel to each transistor 7a, 7b. A capacitor 7c is connected in parallel to the first bridge circuit. The transmission electric power conversion portion 7 includes, for example, a sensor such as a current sensor that detects a current of DC electric power.

The electric power transmission portion 8 is connected to an AC terminal of the first bridge circuit of the transmission electric power conversion portion 7. The electric power transmission portion 8 transmits electric power by a change of a high-frequency magnetic field, for example, by magnetic field coupling such as magnetic field resonance or electromagnetic induction. As shown in FIG. 3 and FIG. 4, the electric power transmission portion 8 includes, for example, a resonance circuit formed of a primary side coil 8a (electric power transmission side coil), a primary side resistance 8b, and a primary side capacitor 8c that are connected in series. The electric power transmission portion 8 includes, for example, a sensor such as a current sensor 9a that detects a current (electric power transmission side current) It that flows through the resonance circuit and a voltage sensor 9b that detects a voltage (electric power transmission side voltage) Vt of the resonance circuit.

The electric power transmission side control device 9 integrally controls the electric power transmission device 2. The electric power transmission side control device 9 is, for example, a software function unit that functions by a predetermined program being executed by a processor such as a CPU (Central Processing Unit). The software function unit is an ECU that includes a processor such as a CPU, a ROM (Read Only Memory) that stores the program, a RAM (Random Access Memory) that temporarily stores data, and an electronic circuit such as a timer. At least part of the electric power transmission side control device 9 may be an integrated circuit such as a LSI (Large Scale Integration).

For example, in an electric power transmission control at the time of electric power transmission between the electric power transmission device 2 and the electric power reception device 4, the electric power transmission side control device 9 independently controls an electric power distribution switch operation of each of the plurality of transmission electric power conversion portions 7. For example, as shown in FIG. 2, the electric power transmission side control device 9 performs independent control for each of the plurality of transmission electric power conversion portions 7 so that a plurality of sets of the transmission electric power conversion portion 7 and the electric power transmission portion 8 perform individual electric power transmission at an appropriate timing including the same time between the electric power reception devices 4 of vehicles V (for example, two different vehicles Va, Vb or the like) different from each other.

The electric power transmission side control device 9 generates, for example, a control signal indicating a timing of driving each switching element to ON (conduction) and OFF (cutoff) for each of the plurality of transmission electric power conversion portions 7 and generates a gate signal for actually driving each switching element to ON and OFF based on the control signal.

For example, the electric power transmission side control device 9 performs electric power transmission to the electric power reception device 4 of the vehicle V that corresponds to each transmission electric power conversion portion 7 and each electric power transmission portion 8 by controlling switching between ON (conduction) and OFF (cutoff) of each switching element in accordance with information of a drive frequency set in advance or a request frequency received from the electric power reception device 4 for each of the plurality of transmission electric power conversion portions 7.

The electric power transmission side control device 9 controls communication between the electric power transmission device 2 and the electric power reception device 4 by the primary side coil 8a and a secondary side coil 15a (electric power reception side coil), for example, before electric power transmission between the electric power transmission device 2 and the electric power reception device 4 is started.

For example, when receiving the information of the combination of the key information and the information relating to the electric power transmission from the communication system M, the electric power transmission side control device 9 understands that the same key information is transmitted to the in-vehicle communication device 5 of the vehicle V and shifts the electric power transmission device 2 from a stop state to a reception standby state. The stop state of the electric power transmission device 2 is, for example, a state of stopping a switching operation in each transmission electric power conversion portion 7 such as a state of maintaining each switching element of each of the plurality of transmission electric power conversion portions 7 in OFF (cutoff). The reception standby state of the electric power transmission device 2 is a state of detecting transmission of the information from the electric power reception device 4 of the vehicle V. The reception standby state of the electric power transmission device 2 is, for example, a short-circuit state of each transmission electric power conversion portion 7.

As shown in FIG. 3, in the short-circuit state of each transmission electric power conversion portion 7, the electric power transmission side control device 9 short-circuits the primary side coil 8a by setting the low-side arm transistor 7b of each phase to ON. Thereby, when looking at the electric power transmission device 2 on the primary side from the electric power reception device 4 on the secondary side, an impedance on the primary side becomes an extremely large value. However, when a magnetic field is generated by the secondary side coil 15a of the electric power reception device 4 at the time of PING transmission described later, communication from the electric power reception device 4 is detected by a voltage induced in the primary side coil 8a of the electric power transmission device 2. The electric power transmission side control device 9 demodulates the voltage detected at the time of PING transmission and thereby acquires information superimposed on a PING signal.

For example, when the electric power transmission side control device 9 receives the key information by the PING signal transmitted from the secondary side coil 15a of the electric power reception device 4 to an appropriate primary side coil 8a of the electric power transmission device 2, the electric power transmission side control device 9 collates the key information based on the combination of the key information and the information relating to the electric power transmission received from the communication system M in advance. When the key information received from the communication system M is matched with the key information received from the electric power reception device 4, the electric power transmission side control device 9 shifts the transmission electric power conversion portion 7 corresponding to the primary side coil 8a that receives the key information from the reception standby state to a search state (search mode). In the search state of the transmission electric power conversion portion 7, the electric power transmission side control device 9 estimates a coupling coefficient k between the primary coil 8a and the secondary coil 15a based on current detection at the electric power transmission portion 8 while outputting a voltage pulse to the primary coil 8a, for example, by an electric power distribution switch operation by the switching at the transmission electric power conversion portion 7.

In the search state of each transmission electric power conversion portion 7, the electric power transmission side control device 9 acquires a mutual inductance Lm and the coupling coefficient k between the primary side coil 8a and the secondary side coil 15a and an efficiency based on each detection value that is output from the current sensor 9a and the voltage sensor 9b of the electric power transmission portion 8. The efficiency is, for example, an AC electric power transmission efficiency η_{AC} when the load of the vehicle V of the contactless electric power transmission system 1 is a constant voltage.

FIG. 5 is a view showing a T-type equivalent circuit in the contactless electric power transmission system 1 of the embodiment.

As shown in FIG. 5, the T-type equivalent circuit of the contactless electric power transmission system 1 is described, for example, by a voltage Vt of an AC voltage source 21, a capacitance Ct, an internal resistance value Rt, a self-inductance Lt, and a current It of the electric power transmission portion 8, the mutual inductance Lm, a capacitance Cr, an internal resistance value Rr, a self-inductance Lr, and a current Ir of the electric power reception portion 15, and a voltage Vr of a load resistance 22.

The load resistance 22 corresponds to, for example, a reception electric power conversion portion 16 (electric power reception side electric power conversion portion) described later and a load resistance A connected between DC terminals (a positive electrode and a negative electrode) of the reception electric power conversion portion 16. The load resistance A is, for example, the drive control device 3 or the like.

The Kirchhoff's law in a closed circuit shown in FIG. 5 is described as shown in the following Expression (1) by an angular frequency ω, an imaginary unit j, and the like.

$$\begin{matrix}[ Expression 1 ] & \\ \begin{matrix}Vt - ( \frac{1}{j ω Ct} + Rt + j ω Lt - j ω Lm ) It - j ω Lm ( It - Ir ) = 0 \\ Vr - ( j ω Lr + Rr + \frac{1}{j ω Cr} - j ω Lm ) Ir - j ω Lm ( Ir - It ) = 0\end{matrix} \} & ( 1 )\end{matrix}$$

When each capacitance Ct, Cr is set so that resonance is obtained at an angular frequency ω₀ in each of the electric power transmission device 2 and the electric power reception device 4, the relationship between each capacitance Ct, Cr and each self-inductance Lt, Lr is described as shown in the following Expression (2).

$$\begin{matrix}[ Expression 2 ] & \\ \begin{matrix}j {ω}_{0} Lt + \frac{1}{j {ω}_{0} Ct} = 0 \\ j {ω}_{0} Lr + \frac{1}{j {ω}_{0} Cr} = 0\end{matrix} \} & ( 2 )\end{matrix}$$

Each current It, Ir is described as shown in the following Expression (3) based on the above Expression (1) and the above Expression (2).

$$\begin{matrix}[ Expression 3 ] & \\ \begin{matrix}It = \frac{Rr \cdot Vt + j {ω}_{0} Lm \cdot Vr}{Rt \cdot Rr + {{ω}_{0}}^{2} \cdot {Lm}^{2}} \\ Ir = \frac{Rt \cdot Vr + j {ω}_{0} Lm \cdot Vt}{Rt \cdot Rr + {{ω}_{0}}^{2} \cdot {Lm}^{2}}\end{matrix} \} & ( 3 )\end{matrix}$$

In relation to a phase relationship between the voltage Vt and the voltage Vr, the reception electric power conversion portion 16 described later of the electric power reception device 4 performs a rectifier operation, and therefore, the voltage Vr and the current Ir basically have the same sign and have no phase difference. Accordingly, the ratio of the voltage Vr and the current Ir described as shown in the following Expression (4) is a real number.

Since the voltage Vt and the voltage Vr are described as shown in the following Expression (5) based on an amplitude ratio α of a real number, for example, it is recognized that the voltage Vr is in a relationship advanced in phase by 90° relative to the voltage Vt.

$$\begin{matrix}[ Expression 4 ] & \\ \frac{Vr}{Ir} = \frac{Rt \cdot Rr + {{ω}_{0}}^{2} \cdot {Lm}^{2}}{j {ω}_{0} Lm \frac{Vt}{Vr} + Rt} & ( 4 )\end{matrix}$$

$$\begin{matrix}[ Expression 5 ] & \\ Vr = - α \cdot j \cdot Vt & ( 5 )\end{matrix}$$

The mutual inductance Lm and the coupling coefficient k are described as shown in the following Expression (6).

An AC output Pt on the electric power transmission side and an AC output Pr on the electric power reception side are described as shown in the following Expression (7) based on the above Expression (5), the following Expression (6), and an average current It (ave), Ir (ave) based on the above Expression (3).

$$\begin{matrix}[ Expression 6 ] & \\ Lm = k \sqrt{Lt \cdot Lr} & ( 6 )\end{matrix}$$

$$\begin{matrix}[ Expression 7 ] & \\ \begin{matrix}Pt = Vt \cdot It ( ave ) = \frac{Rr + {αω}_{0} k \sqrt{Lt \cdot Lr}}{Rt \cdot Rr + {{ω}_{0}}^{2} \cdot {k}^{2} \cdot Lt \cdot Lr} {Vt}^{2} \\ Pr = Vr \cdot Ir ( ave ) = α \frac{{ω}_{0} k \sqrt{Lt \cdot Lr} - α Rt}{Rt \cdot Rr + {{ω}_{0}}^{2} \cdot {k}^{2} \cdot Lt \cdot Lr} {Vt}^{2}\end{matrix} \} & ( 7 )\end{matrix}$$

As shown in the following Expression (8), the AC electric power transmission efficiency η_{AC} is described by the ratio of the average of real parts Re (Pt), Re (Pr) of AC outputs Pt, Pr of the above Expression (7). The AC electric power transmission efficiency η_{AC} is described by each resistance value Rt, Rr, each self-inductance Lt, Lr, and the angular frequency do that are circuit constants unique to a system, a voltage ratio α obtained by the PING signal described later, and the coupling coefficient k that changes during traveling of the vehicle V.

$$\begin{matrix}[ Expression 8 ] & \\ {η}_{AC} = \frac{Re ( Pr )}{Re ( Pt )} = α \frac{{ω}_{0} k \sqrt{Lt \cdot Lr} - α Rt}{{αω}_{0} k \sqrt{Lt \cdot Lr} + Rr} & ( 8 )\end{matrix}$$

The coupling coefficient k is described as shown in the following Expression (9) based on the above Expressions (5), the above Expression (6), and the current It of the above Expression (3).

$$\begin{matrix}[ Expression 9 ] & \\ k = \frac{\frac{α Vt}{It} + \sqrt{{( \frac{α Vt}{It} )}^{2} - 4 Rt \cdot Rr + 4 Rr \frac{Vt}{It}}}{2 {ω}_{0} \sqrt{Lt \cdot Lr}} & ( 9 )\end{matrix}$$

The electric power transmission side control device 9 obtains a conversion efficiency from AC to AC by detection values of the voltage Vt and the current It on the electric power transmission side based on the above Expression (8) and the above Expression (9). The electric power transmission side control device 9 further adds the loss of conversion between AC and DC and thereby obtains a conversion efficiency (overall electric power transmission efficiency) from DC to DC.

For example, when the coupling coefficient k estimated in the search state of each transmission electric power conversion portion 7 reaches a predetermined value ka or more within a predetermined time, the electric power transmission side control device 9 shifts each transmission electric power conversion portion 7 from the search state to an electric power transmission control state. The predetermined value ka is, for example, a value corresponding to a predetermined value (for example, 80% or the like) of the efficiency (for example, an overall efficiency or the like) of electric power transmission. The electric power transmission control state of each transmission electric power conversion portion 7 is, for example, a state in which the electric power transmission at the request electric power and the request frequency of the electric power reception device 4 is controlled.

On the other hand, the electric power transmission side control device 9 causes each transmission electric power conversion portion 7 to return to the reception standby state from the search state, for example, when the coupling coefficient k estimated in the search state of each transmission electric power conversion portion 7 does not reach the predetermined value ka or more within the predetermined time.

The electric power transmission side control device 9 performs a control of stopping electric power transmission, for example, when the coupling coefficient k estimated in the electric power transmission control state of each transmission electric power conversion portion 7 is less than the predetermined value ka or when a duration time from the start of the electric power transmission control state reaches a predetermined first time or more. The predetermined first time is, for example, a threshold time for determining whether or not the electric power transmission control state is temporarily stopped in order to confirm or change information relating to electric power transmission in the electric power transmission control state. For example, when the coupling coefficient k estimated in the electric power transmission control state of each transmission electric power conversion portion 7 is less than the predetermined value ka, the electric power transmission side control device 9 stops the electric power transmission by each transmission electric power conversion portion 7. For example, when the duration time from the start of the electric power transmission control state of each transmission electric power conversion portion 7 reaches the predetermined first time or more, the electric power transmission side control device 9 temporarily stops the electric power transmission control state of each transmission electric power conversion portion 7 and attempts to reacquire the information relating to the electric power transmission and restart the electric power transmission control state.

The details of a control operation of the electric power transmission side control device 9 will be described later.

As shown in FIG. 1, FIG. 2 and FIG. 3, the drive control device 3 of the vehicle V includes, for example, an electric power storage device 11, an electric power conversion portion 13, and a rotary electric machine 14. The electric power reception device 4 of the vehicle V includes, for example, the electric power reception portion 15 and the reception electric power conversion portion 16. The drive control device 3 and the electric power reception device 4 include, for example, a common electric power reception side control device 17.

The electric power storage device 11 is connected to the electric power conversion portion 13 and the reception electric power conversion portion 16, which will be described later. The electric power storage device 11 is charged by electric power transmitted in a contactless manner from the electric power transmission device 2 at the outside of the vehicle V. The electric power storage device 11 performs transmission and reception of electric power with the rotary electric machine 14 via the electric power conversion portion 13.

The electric power storage device 11 includes, for example, a battery, a current sensor that detects a current of the battery, and a voltage sensor that detects a voltage of the battery. The battery is, for example, a secondary battery such as a lead storage battery, a lithium ion battery, a sodium ion battery, a nickel hydrogen battery, and an all-solid state battery, a capacitor such as an electric double layer capacitor, a composite battery formed by a combination of a secondary battery and a capacitor, or the like. The electric power conversion portion 13 is connected to the rotary electric machine 14. The electric power conversion portion 13 includes, for example, a second element module that performs conversion between DC electric power and AC electric power and a capacitor for voltage smoothing.

The second element module includes, for example, a second bridge circuit formed of a plurality of switching elements connected in three phases by bridge connection and a rectifier element. Each switching element is, for example, a transistor such as an IGBT (Insulated Gate Bipolar Transistor) or a SiC MOSFET. The plurality of switching elements are high-side arm and low-side arm transistors 13a, 13b that form a pair in each phase. The rectifier element is, for example, a reflux diode connected in parallel to each transistor 13a, 13b. The capacitor 13c for voltage smoothing is connected in parallel to the second bridge circuit.

The second element module controls an operation of the rotary electric machine 14 by transmission and reception of electric power. For example, at the time of power running of the rotary electric machine 14, the second element module converts DC electric power that is input from DC terminals 13p, 13n of a positive electrode and a negative electrode into three-phase AC electric power and supplies the three-phase AC electric power from a three-phase AC terminal 13d to the rotary electric machine 14. The second element module generates a rotation drive force by sequentially commutating electric power supply to a three-phase stator winding of the rotary electric machine 14.

For example, at the time of regeneration of the rotary electric machine 14, the second element module converts the three-phase AC electric power that is input from the three-phase stator winding into DC electric power by the driving between ON (conduction) and OFF (cutoff) of the switching element of each phase synchronized with the rotation of the rotary electric machine 14. The second element module is capable of supplying the DC electric power converted from the three-phase AC electric power to the electric power storage device 11.

The rotary electric machine 14 is, for example, a three-phase AC brushless DC motor provided for traveling and driving of the vehicle V. The rotary electric machine 14 includes a rotor having a field permanent magnet and a stator having a three-phase stator winding that generates a rotation magnetic field which rotates the rotor. The three-phase stator winding is connected to the three-phase AC terminal 13d of the electric power conversion portion 13.

The rotary electric machine 14 generates a rotation drive force by performing a power running operation by electric power that is supplied from the electric power conversion portion 13. For example, when the rotary electric machine 14 is connected to a wheel of the vehicle V, the rotary electric machine 14 generates a travel drive force by performing the power running operation by the electric power that is supplied from the electric power conversion portion 13. The rotary electric machine 14 may generate electric power by performing a regeneration operation by a rotation power that is input from the wheel side of the vehicle V. When the rotary electric machine 14 is connected to an internal combustion engine of the vehicle V, the rotary electric machine 14 may generate electric power by the power of the internal combustion engine.

The electric power reception portion 15 is connected to an AC terminal of a third bridge circuit of the reception electric power conversion portion 16 described later. The electric power reception portion 15 receives electric power by a change of a high-frequency magnetic field that is transmitted from the electric power transmission portion 8, for example, by magnetic field coupling such as magnetic field resonance or electromagnetic induction. As shown in FIG. 4, the electric power reception portion 15 includes, for example, a resonance circuit formed of the secondary side coil 15a, a secondary side resistance 15b, and a secondary side capacitor 15c that are connected in series. The electric power reception portion 15 includes, for example, a sensor such as a current sensor that detects a current (electric power reception side current) Ir that flows through the resonance circuit and a voltage sensor that detects a voltage (electric power reception side voltage) Vr of the resonance circuit.

The reception electric power conversion portion 16 shown in FIG. 1, FIG. 2, and FIG. 3 is connected to the electric power conversion portion 13. The reception electric power conversion portion 16 includes a so-called full-bridgeless (or bridgeless and totem-pole) power factor correction (PFC) circuit that converts AC electric power into DC electric power. The so-called bridgeless PFC is a PFC that does not include a bridge rectifier by a plurality of diodes connected by bridge connection. The so-called totem-pole PFC is a PFC that includes a pair of switching elements having the same conductivity type connected (totem-pole connection) in series in the same direction.

The reception electric power conversion portion 16 includes, for example, a capacitor and a third bridge circuit formed of a plurality of switching elements connected in two phases by bridge connection and a rectifier element. Each switching element is, for example, a transistor such as a SiC MOSFET. The plurality of switching elements are high-side arm and low-side arm transistors 16a, 16b that form a pair in each phase. The rectifier element is, for example, a reflux diode connected in parallel to each transistor 16a, 16b. The capacitor 16c is connected in parallel to the third bridge circuit.

The reception electric power conversion portion 16 includes, for example, a sensor such as a current sensor that detects a current of DC electric power.

For example, the electric power reception device 4 that includes the electric power reception portion 15 and the reception electric power conversion portion 16 receives electric power transmitted from the electric power transmission device 2 by controlling the switching between ON (conduction) and OFF (cutoff) of each switching element of the reception electric power conversion portion 16 in accordance with information of a frequency of electric power transmission by the electric power transmission device 2.

The electric power reception side control device 17 integrally controls, for example, the drive control device 3, the electric power reception device 4, and the in-vehicle communication device 5 of the vehicle V. The electric power reception side control device 17 is, for example, a software function unit that functions by a predetermined program being executed by a processor such as a CPU (Central Processing Unit). The software function unit is an ECU that includes the processor such as a CPU, a ROM (Read-Only Memory) that stores the program, a RAM (Random-Access Memory) that temporarily stores data, and an electronic circuit such as a timer. At least part of the electric power reception side control device 17 may be an integrated circuit such as a LSI (Large Scale Integration).

For example, in an electric power reception control at the time of electric power transmission between the electric power transmission device 2 and the electric power reception device 4, the electric power reception side control device 17 controls an electric power distribution switch operation of each of the drive control device 3 and the electric power reception device 4. For example, the electric power reception side control device 17 generates a control signal indicating a timing of driving each switching element of the drive control device 3 and the electric power reception device 4 to ON (conduction) and OFF (cutoff) and generates a gate signal for driving each switching element actually to ON and OFF on the basis of the control signal.

For example, by controlling the switching of each switching element of the electric power reception device 4, the electric power reception side control device 17 performs the power factor correction of the input voltage and the input current while rectifying AC electric power received from the electric power transmission device 2 to DC electric power.

For example, the electric power reception side control device 17 controls an output in accordance with a target output by a synchronous rectification operation that synchronously drives the plurality of switching elements of the electric power reception device 4 to ON and OFF and a short-circuit operation that short-circuits the secondary side coil 15a.

For example, the electric power reception side control device 17 controls the synchronous rectification operation in accordance with the magnitude and the phase of a current generated in the electric power reception portion 15 by electric power that is transmitted from the electric power transmission device 2, that is, the current Ir that flows through the secondary side coil 15a. The electric power reception side control device 17 controls the plurality of switching elements of the reception electric power conversion portion 16 by soft switching of so-called zero voltage switching (ZVS). In the zero voltage switching (ZVS), after a voltage of both ends of each switching element is set to zero by the discharge of an output capacitance (parasitic capacitance) in an OFF state in a dead time period of each phase, turn-on (switching from an OFF state to an ON state) of each switching element is performed.

For example, the electric power reception side control device 17 controls the short-circuit operation by turning on only the low-side arm of each phase while continuing the synchronous rectification operation of the zero voltage switching (ZVS) at the high-side arm of each phase of the reception electric power conversion portion 16. By short-circuiting the secondary side coil 15a, the electric power reception side control device 17 increases an impedance on the secondary side when the electric power reception device 4 on the secondary side is seen from the electric power transmission device 2 on the primary side and reduces a current (electric power transmission side current: the current It that flows through the primary side coil 8a) on the primary side. The electric power reception side control device 17 controls the current It of the electric power transmission device 2 on the primary side by the electric power reception device 4 on the secondary side and thereby performs an independent electric power control such as electric power transmission stoppage on the electric power reception device 4 side.

The electric power reception side control device 17 controls communication between the electric power transmission device 2 and the electric power reception device 4 by the primary side coil 8a and the secondary side coil 15a, for example, before electric power transmission between the electric power transmission device 2 and the electric power reception device 4 is started.

For example, the electric power reception side control device 17 defines a zone in which a coupling degree between the primary side coil 8a of the electric power transmission device 2 and the secondary side coil 15a of the electric power reception device 4 is equal to or more than a predetermined degree in the vicinity of the electric power transmission device 2 as a coupling zone. The electric power reception side control device 17 sets, in the coupling zone, a communication zone for communication by the primary side coil 8a and the secondary side coil 15a and an electric power transmission zone for electric power transmission. The communication zone is, for example, a first communication zone and a second communication zone set before and after the electric power transmission zone along a movement direction of the vehicle V.

The electric power reception side control device 17 defines, for example, the coupling zone in which the coupling degree between the primary side coil 8a and the secondary side coil 15a is equal to or more than the predetermined degree as a zone in which the efficiency of electric power transmission is equal to or more than a predetermined value (zero or the like). The electric power reception side control device 17 defines, in the coupling zone, a zone in which the efficiency of electric power transmission is equal to or more than a first predetermined value (for example, 80% or the like), and a relative horizontal distance between the primary side coil 8a and the secondary side coil 15a is equal to or less than a first predetermined distance as an electric power transmission zone in which the coupling degree between the primary side coil 8a and the secondary side coil 15a is relatively large. The electric power reception side control device 17 defines, in the coupling zone, a zone in which the efficiency of electric power transmission is less than the first predetermined value and is equal to or more than a second predetermined value (for example, 0% or the like), and the relative horizontal distance between the primary side coil 8a and the secondary side coil 15a is larger than the first predetermined distance and is equal to or less than a second predetermined distance as a communication zone in which the coupling degree between the primary side coil 8a and the secondary side coil 15a is relatively small. The communication zone is, for example, the first communication zone and the second communication zone set before and after the electric power transmission zone along the movement direction of the vehicle V. A state in which the horizontal distance is zero is, for example, a state in which center axis lines of the primary side coil 8a and the secondary side coil 15a become identical to each other. The electric power transmitted in the electric power transmission zone is regulated to, for example, an appropriate request electric power or less.

For example, when receiving the key information and the information relating to the installation of the electric power transmission device 2 by the communication between the roadside communicator Ma of the communication system M and the in-vehicle communication device 5 before the vehicle V reaches the coupling zone, the electric power reception side control device 17 sets a communication timing in the communication zone. The electric power reception side control device 17 sets the communication timing of an initial communication zone, that is, the first communication zone for each of the plurality of electric power transmission portions 8, for example, in accordance with a travel state (that is, a movement state of the electric power reception device 4) of the vehicle V and information of an installation interval of the plurality of electric power transmission portions 8, the distance from the roadside communicator Ma, and the like.

For example, when the electric power reception portion 15 reaches a first communication zone of an appropriate electric power transmission portion 8, the electric power reception side control device 17 shifts the electric power reception device 4 from the short-circuit state to a transmission state. The short-circuit state of the electric power reception device 4 is a state in which the secondary side coil 15a is short-circuited by setting the low-side arm transistor 16b of each phase of the reception electric power conversion portion 16 to ON. The transmission state of the electric power reception device 4 is a state in which second information is transmitted by a so-called PING signal from the secondary side coil 15a to the transmission electric power conversion portion 7 and the primary side coil 8a in the reception standby state. The electric power reception side control device 17 communicates, for example, by a voltage induced in the primary side coil 8a of the electric power transmission device 2 by a magnetic field generated in the secondary side coil 15a by an electric power distribution switch operation using the switching at the reception electric power conversion portion 16.

The electric power reception side control device 17 generates digital signals of two levels which are so-called dominant and recessive levels, for example, by performing the switching of a carrier wave for transmitting electric power in a contactless manner from the secondary side coil 15a to the primary side coil 8a at a predetermined duty ratio and thereby performs the PING transmission. The predetermined duty ratio is, for example, from a predetermined minimum to about 50%. The electric power reception side control device 17 may transmit the second information, for example, by amplitude modulation of the carrier wave by changing the duty ratio of the switching.

The electric power reception side control device 17 performs the PING transmission, for example, at a predetermined cycle from a few tens of microseconds to about a few milliseconds or the like and transmits information relating to electric power transmission in the electric power transmission zone as the second information from the secondary side coil 15a to the primary side coil 8a. Examples of the information relating to electric power transmission include key information acquired by the in-vehicle communication device 5 from the roadside communicator Ma, a request frequency of electric power transmission, a voltage Vr of the electric power reception portion 15, a target output (request electric power, electric power consumption) for failsafe, and information relating to various abnormalities.

The request frequency of the electric power transmission is a frequency required for electric power transmission of the electric power transmission device 2 and is set in accordance with the request electric power. The request frequency is set so as to prevent the decrease of the efficiency of electric power transmission and the output (electric power), for example, on the basis of a minimum ground height of the vehicle V, the mounting layout of the electric power reception device 4 in the vehicle V, and the like which are related to the distance between the primary side coil 8a and the secondary side coil 15a. The request frequency may be set, for example, in accordance with the state of electric power transmission between the electric power transmission device 2 and the electric power reception device 4.

The target output of electric power transmission is a target value of electric power received by the electric power reception device 4 from the electric power transmission device 2 and is set, for example, in accordance with a target drive force of the vehicle V or the rotary electric machine 14, electric power consumption of various auxiliary machines connected to the electric power storage device 11, a remaining capacity (SOC: State Of Charge) of the electric power storage device 11, and the like.

For example, when at least a predetermined number of times (one time or the like) of PING transmissions are completed, the electric power reception side control device 17 shifts the electric power reception device 4 from the transmission state to an electric power reception standby state. The electric power reception standby state of the electric power reception device 4 is a state of receiving electric power that is transmitted from the primary side coil 8a and the transmission electric power conversion portion 7 in the search state. For example, when the reception electric power that is detected in the electric power reception standby state reaches predetermined electric power or more within a predetermined time, that is, when the electric power reception portion 15 reaches the electric power transmission zone, the electric power reception side control device 17 shifts the electric power reception device 4 from the electric power reception standby state to an electric power reception control state. The predetermined electric power is, for example, a predetermined value (for example, 80% or the like) of the efficiency (for example, an overall efficiency or the like) of electric power transmission, that is, a value corresponding to the predetermined value ka of the coupling coefficient k estimated by the electric power transmission side control device 9.

On the other hand, the electric power reception side control device 17 causes the electric power reception device 4 to return to the transmission state from the electric power reception standby state, for example, when the reception electric power that is detected in the electric power reception standby state does not reach the predetermined electric power or more within the predetermined time, that is, when the electric power reception portion 15 does not reach the electric power transmission zone TS.

For example, when a duration time from the start of the electric power reception control state of the reception electric power conversion portion 16 reaches a predetermined first time or more, the electric power reception side control device 17 performs a control of stopping the electric power reception control state. The predetermined first time is, for example, a threshold time for determining whether or not the PING transmission is performed in order to update the information relating to electric power transmission in the electric power reception control state.

Details of a control operation of the electric power reception side control device 17 will be described later.

Hereinafter, as an operation of the contactless electric power transmission system 1, a process performed by the electric power transmission side control device 9 and the electric power reception side control device 17 is described.

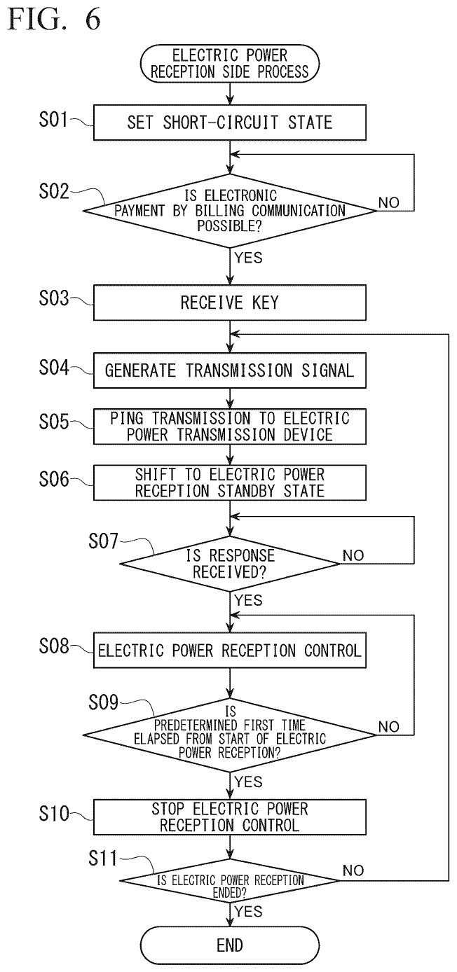

FIG. 6 is a flowchart showing an electric power reception side process performed by the electric power reception side control device 17 of the contactless electric power transmission system 1 in the embodiment.

First, in Step S01 shown in FIG. 6, the electric power reception side control device 17 sets the electric power reception device 4 to the short-circuit state.

Next, in Step S02, the electric power reception side control device 17 determines whether or not electronic payment for electric power transmission from the electric power transmission device 2 to the vehicle V is possible by transmission and reception (billing communication) of information by a wireless communication between the roadside communicator Ma of the communication system M and the in-vehicle communication device 5. When the determination result is “NO”, the electric power reception side control device 17 repeats the process of Step S02. On the other hand, when the determination result is “YES”, the electric power reception side control device 17 advances the process to Step S03.

Then, in Step S03, the electric power reception side control device 17 acquires key information required for the start of electric power transmission from the roadside communicator Ma via the in-vehicle communication device 5.

Next, in Step S04, the electric power reception side control device 17 shifts the electric power reception device 4 from the short-circuit state to the transmission state, for example, when the electric power reception portion 15 reaches the first communication zone CS1 of an appropriate electric power transmission portion 8. The electric power reception side control device 17 generates a signal for PING transmission from the secondary side coil 15a of the electric power reception device 4 to the primary side coil 8a of the appropriate electric power transmission portion 8 of the electric power transmission device 2.

Next, in Step S05, the electric power reception side control device 17 performs the PING transmission to the primary side coil 8a of the appropriate electric power transmission portion 8 of the electric power transmission device 2 in the first communication zone CS1 at a predetermined cycle.

Next, in Step S06, when at least a predetermined number of times (one time or the like) of PING transmissions are completed, the electric power reception side control device 17 shifts the electric power reception device 4 from the transmission state to the electric power reception standby state.

Next, in Step S07, the electric power reception side control device 17 determines whether or not a response signal to the PING transmission from the electric power transmission portion 8 is received. When the determination result is “NO”, the electric power reception side control device 17 repeats the process of Step S07. On the other hand, when the determination result is “YES”, the electric power reception side control device 17 advances the process to Step S08.

Next, in Step S08, the electric power reception side control device 17 performs an electric power reception control with respect to electric power transmission from the electric power transmission device 2 in the electric power transmission zone TS.

Next, in Step S09, the electric power reception side control device 17 determines whether or not the duration time from the start of the electric power reception control state reaches a predetermined first time or more. When the determination result is “NO”, the electric power reception side control device 17 causes the process to return to Step S08. On the other hand, when the determination result is “YES”, the electric power reception side control device 17 advances the process to Step S10.

Next, in Step S10, the electric power reception side control device 17 stops the electric power reception control.

Next, in Step S11, the electric power reception side control device 17 determines whether or not electric power reception is ended. When the determination result is “NO”, the electric power reception side control device 17 causes the process to return to Step S04. On the other hand, when the determination result is “YES”, the electric power reception side control device 17 advances the process to the end.

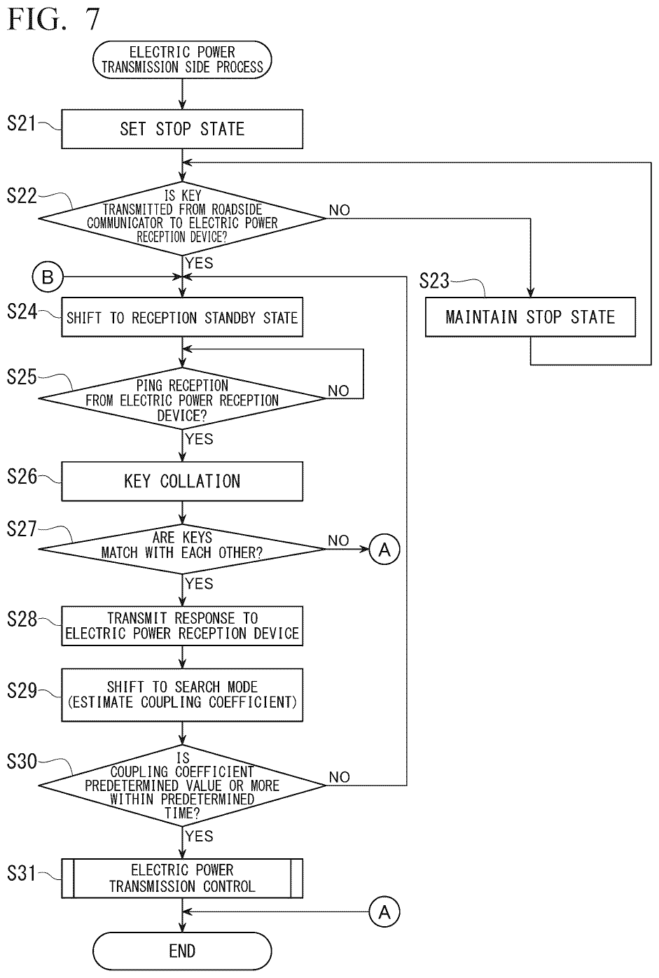

FIG. 7 is a flowchart showing an electric power transmission side process performed by the electric power transmission side control device 9 of the contactless electric power transmission system 1 in the embodiment.

First, in Step S21 shown in FIG. 7, the electric power transmission side control device 9 sets the electric power transmission device 2 to the stop state.

Next, in Step S22, the electric power transmission side control device 9 determines whether or not the key information is transmitted from the roadside communicator Ma to the electric power reception device 4. When the determination result is “NO”, the electric power transmission side control device 9 advances the process to Step S23. On the other hand, when the determination result is “YES”, the electric power transmission side control device 9 advances the process to Step S24.

Then, in Step S23, the electric power transmission side control device 9 maintains the stop state of the electric power transmission device 2 and causes the process to return to Step S22.

Then, in Step S24, the electric power transmission side control device 9 shifts the electric power transmission device 2 from the stop state to the reception standby state.

Next, in Step S25, the electric power transmission side control device 9 determines whether or not a PING signal that is transmitted from the secondary side coil 15a to the primary side coil 8a is received in the first communication zone of any of the electric power transmission portions 8. When the determination result is “NO”, the electric power transmission side control device 9 repeats the process of Step S25. On the other hand, when the determination result is “YES”, the electric power transmission side control device 9 advances the process to Step S26.

Next, in Step S26, the electric power transmission side control device 9 collates the key information received from the communication control device Mb in advance and the key information received by the primary side coil 8a from the secondary side coil 15a of the electric power reception device 4.

Next, in Step S27, the electric power transmission side control device 9 determines whether or not the key information (that is, the same key information as the key information transmitted from the communication system M to the in-vehicle communication device 5) received from the communication system M matches the key information received by the primary side coil 8a from the secondary side coil 15a of the electric power reception device 4. When the determination result is “YES”, that is, when the pairing between the secondary side coil 15a of the electric power reception device 4 and the primary side coil 8a of the electric power transmission portion 8 that receives the PING signal transmitted from the electric power reception device 4 is established, the electric power transmission side control device 9 advances the process to Step S28.

On the other hand, when the determination result is “NO”, the electric power transmission side control device 9 advances the process to the end.

Next, in Step S28, the electric power transmission side control device 9 transmits a response signal to the PING transmission from the electric power reception device 4 to the electric power reception device 4 via the secondary side coil 15a and the primary side coil 8a with which the pairing is established.

Next, in Step S29, the electric power transmission side control device 9 shifts the transmission electric power conversion portion 7 corresponding to the primary side coil 8a with which the pairing is established from the reception standby state to the search state (search mode). In the search state of each transmission electric power conversion portion 7, the electric power transmission side control device 9 acquires the mutual inductance Lm and the coupling coefficient k with the secondary side coil 15a and the primary side coil 8a with which the pairing is established and the efficiency of electric power transmission on the basis of the above Expression (8), the above Expression (9), and detection values that are output from the current sensor 9a and the voltage sensor 9b of the electric power transmission portion 8.

Next, in Step S30, the electric power transmission side control device 9 determines whether or not the coupling coefficient k estimated in the search state of the transmission electric power conversion portion 7 reaches the predetermined value (predetermined threshold value) ka or more within a predetermined time. When the determination result is “NO”, the electric power transmission side control device 9 causes the process to return to Step S24. On the other hand, when the determination result is “YES”, the electric power transmission side control device 9 advances the process to Step S31.

Then, in Step S31, the electric power transmission side control device 9 performs the electric power transmission control with respect to electric power transmission by the transmission electric power conversion portion 7 and the electric power transmission portion 8 in the electric power transmission zone. Then, the electric power transmission side control device 9 advances the process to the end.

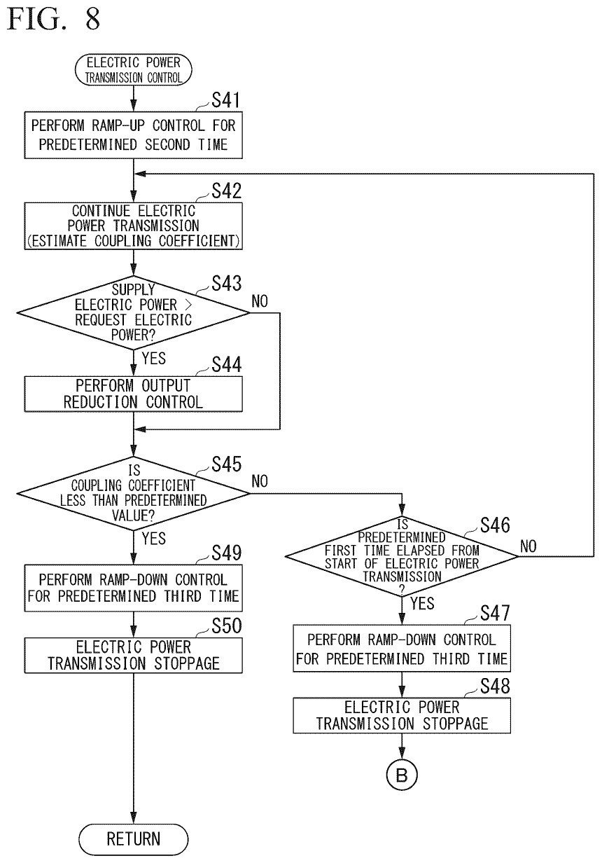

FIG. 8 is a flowchart showing the electric power transmission control shown in FIG. 7.

First, in Step S41 shown in FIG. 8, the electric power transmission side control device 9 performs a ramp-up control in a period of a predetermined second time from the start of electric power transmission. The predetermined second time is set, for example, based on at least one of a supply capacity of the electric power source portion 6, the number of electric power transmission portions 8 connected to the electric power source portion 6, and a movement speed (speed of a movable body or the like) of the electric power reception device 4 relative to the electric power transmission portion 8.

The predetermined second time is, for example, a time between a few tens of microseconds and about a few milliseconds. In the ramp-up control, the electric power transmission side control device 9 sets, for example, the transmission electric power (supply electric power) from the electric power transmission portion 8 to be less than predetermined electric power and changes the transmission electric power in an increasing tendency toward the predetermined electric power in accordance with a time elapse from an electric power transmission start. The predetermined electric power is, for example, request electric power of the electric power reception device 4.

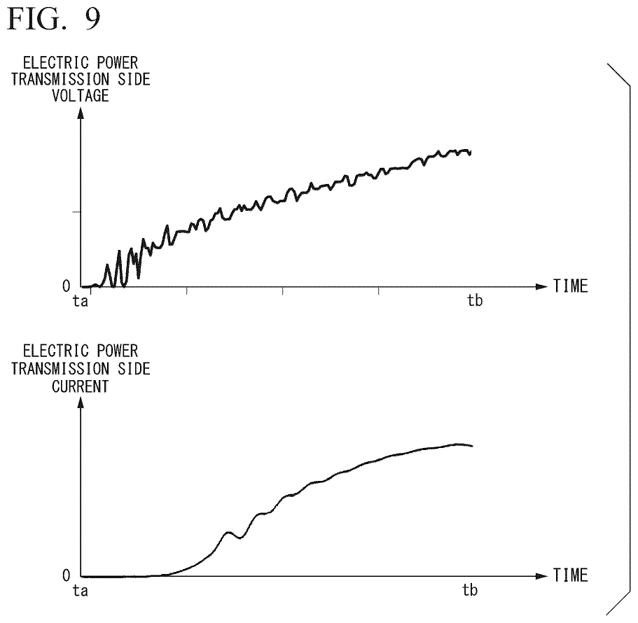

FIG. 9 is a view showing an example of changes of an electric power transmission side voltage and an electric power transmission side current in a ramp-up control of the contactless electric power transmission system 1 of the embodiment.

As shown in FIG. 9, it is recognized that the electric power transmission side voltage (for example, the AC voltage effective value of a coil end of the electric power transmission portion 8 or the like) gradually increases in accordance with the time elapse in a period from a time ta to a time tb when the ramp-up control is performed. It is recognized that with the increase of the electric power transmission side voltage, the electric power transmission side current (for example, a DC current of the electric power transmission device 2 or the like) gradually increases without causing an overcurrent.

In the ramp-up control, the electric power transmission side control device 9 controls the transmission electric power, for example, by the duty ratio or the phase shift amount of the gate signal (pulse signal) that commands the switching operation of the transmission electric power conversion portion 7. The duty ratio is, for example, the ratio of an ON time of one (for example, the high-side arm transistor 7a) of the transistors 7a, 7b that form a pair in each phase of the transmission electric power conversion portion 7 in one cycle of the switching control or the like. The phase shift amount is, for example, a phase difference of a gate signal of a second phase of two phases of the transmission electric power conversion portion 7 relative to a gate signal of a first phase of the two phases.

The electric power transmission side control device 9 changes the electric power transmission side voltage in an increasing tendency, for example, by gradually or continuously changing the duty ratio or the phase shift amount in the increasing tendency.

Next, in Step S42 shown in FIG. 8, the electric power transmission side control device 9 repeatedly continues acquisition of the mutual inductance Lm and the coupling coefficient k with the secondary side coil 15a and the primary side coil 8a with which the pairing is established and the efficiency of the electric power transmission while continuing the electric power transmission by the electric power transmission portion 8.

Next, in Step S43, the electric power transmission side control device 9 determines whether or not the transmission electric power (supply electric power) from the electric power transmission portion 8 is larger than predetermined electric power (for example, the request electric power of the electric power reception device 4), for example, based on detection values of currents by various current sensors of the electric power transmission device 2. When the determination result is “NO”, the electric power transmission side control device 9 advances the process to Step S45. On the other hand, when the determination result is “YES”, the electric power transmission side control device 9 advances the process to Step S44.

Next, in Step S44, the electric power transmission side control device 9 performs an output reduction control. In the output reduction control, the electric power transmission side control device 9 changes the transmission electric power from the electric power transmission portion 8 in a decreasing tendency toward the predetermined electric power, for example, by a feedback control based on the detection value of the current or the like.

Next, in Step S45, the electric power transmission side control device 9 determines whether or not the coupling coefficient k is less than the predetermined value (predetermined threshold value) ka. When the determination result is “NO”, the electric power transmission side control device 9 advances the process to Step S46. On the other hand, when the determination result is “YES”, the electric power transmission side control device 9 advances the process to Step S49.

Next, in Step S46, the electric power transmission side control device 9 determines whether or not the duration time from the start of the electric power transmission control state reaches the predetermined first time or more. When the determination result is “NO”, the electric power transmission side control device 9 causes the process to return to Step S42. On the other hand, when the determination result is “YES”, the electric power transmission side control device 9 advances the process to Step S47.

Next, in Step S47, the electric power transmission side control device 9 performs the ramp-down control in a period of a predetermined third time. The predetermined third time is set, for example, based on at least one of a supply capacity of the electric power source portion 6, the number of electric power transmission portions 8 connected to the electric power source portion 6, and a movement speed (speed of a movable body or the like) of the electric power reception device 4 relative to the electric power transmission portion 8. The predetermined third time is, for example, a time between a few tens of microseconds and about a few milliseconds. In the ramp-down control, the electric power transmission side control device 9 changes the transmission electric power (supply electric power) from the electric power transmission portion 8 in a decreasing tendency toward zero, for example, in accordance with a time elapse of time until electric power transmission stoppage.

Next, in Step S47, the electric power transmission side control device 9 stops the electric power transmission by the electric power transmission portion 8 and causes the process to return to Step S24.

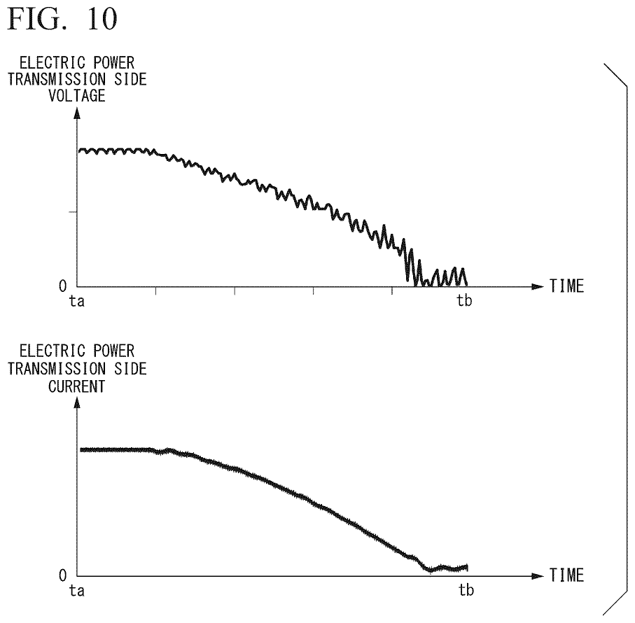

FIG. 10 is a view showing an example of changes of the electric power transmission side voltage and the electric power transmission side current in a ramp-down control of the contactless electric power transmission system 1 of the embodiment.

As shown in FIG. 10, it is recognized that the electric power transmission side voltage (for example, an AC voltage effective value of a coil end of the electric power transmission portion 8 or the like) gradually decreases in accordance with the time elapse in a period from a time ta to a time tb when the ramp-down control is performed. It is recognized that with the decrease of the electric power transmission side voltage, the electric power transmission side current (for example, a DC current of the electric power transmission device 2 or the like) gradually decreases without causing an overcurrent.

In the ramp-down control, the electric power transmission side control device 9 controls the transmission electric power, for example, by the duty ratio or the phase shift amount of the gate signal (pulse signal) that commands the switching operation of the transmission electric power conversion portion 7. The electric power transmission side control device 9 changes the electric power transmission side voltage in a decreasing tendency, for example, by gradually or continuously changing the duty ratio or the phase shift amount in the decreasing tendency.

Further, in Step S49 shown in FIG. 8, the electric power transmission side control device 9 performs the ramp-down control in a period of the predetermined third time.

Next, in Step S50, the electric power transmission side control device 9 stops the electric power transmission by the electric power transmission portion 8 and advances the process to the return.

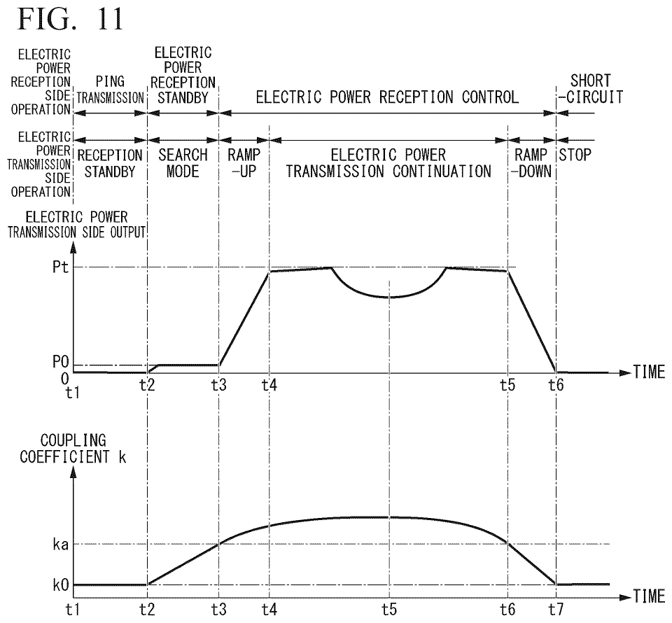

FIG. 11 is a view showing an example of a correspondence relationship between an electric power transmission side output and a coupling coefficient in the contactless electric power transmission system 1 of the embodiment.

As shown in FIG. 11, for example, at a time t1 or before the time t1, the electric power transmission side control device 9 sets the electric power transmission device 2 into the stop state, and the electric power reception side control device 17 sets the electric power reception device 4 into the short-circuit state.

For example, at the time t1, when the electric power transmission side control device 9 receives the information of the combination of the key information and the information relating to the electric power transmission from the communication system M, the electric power transmission side control device 9 shifts the electric power transmission device 2 from the stop state to the reception standby state. When the electric power reception portion 15 reaches a first communication zone of an appropriate electric power transmission portion 8, the electric power reception side control device 17 shifts the electric power reception device 4 from the short-circuit state to the transmission state.

The electric power reception side control device 17 performs at least a predetermined number of times (one time or the like) of PING transmissions over the period of the transmission state. When receiving the key information by the PING signal, the electric power transmission side control device 9 collates the key information based on the key information received from the communication system M in advance.

For example, as shown at a time t2 or after the time t2, the electric power reception side control device 17 shifts the electric power reception device 4 from the transmission state to the electric power reception standby state after the PING transmission is completed. When the key information received from the communication system M matches the key information received from the electric power reception device 4, the electric power transmission side control device 9 shifts the transmission electric power conversion portion 7 corresponding to the primary side coil 8a that receives the key information from the reception standby state to the search state (search mode).

The electric power transmission side control device 9 estimates the coupling coefficient k between the primary side coil 8a and the secondary side coil 15a based on the current detection at the electric power transmission portion 8 while outputting a voltage pulse to the primary side coil 8a by an electric power distribution switch operation by the switching at the transmission electric power conversion portion 7 in the search state (search mode), for example, from the time t2 to a time t3. The electric power transmission side control device 9 shifts the transmission electric power conversion portion 7 from the search state (search mode) to the electric power transmission control state, for example, at the time t3 when the coupling coefficient k increases from an appropriate initial value k0 and reaches the predetermined value ka or more within a predetermined time. The electric power reception side control device 17 shifts the electric power reception device 4 from the electric power reception standby state to the electric power reception control state at the time t3 when the reception electric power detected in the electric power reception standby state reaches the predetermined electric power or more within the predetermined time in accordance with the coupling coefficient k reaching the predetermined value ka or more.

The electric power transmission side control device 9 performs the ramp-up control in a (low-efficiency) region where the coupling degree is relatively small in the electric power transmission zone where the efficiency of electric power transmission is equal to or more than a predetermined efficiency (for example, 80% or the like), for example, in a period from the time t3 to a time t4. The electric power transmission side output is gradually increased, for example, from an initial output P0 toward a predetermined output Pt by the ramp-up control.

For example, as in the time t4 or thereafter, after the ramp-up control is ended, the electric power transmission side control device 9 continues the electric power transmission control that regulates the transmission electric power (supply electric power) of the electric power transmission portion 8 to predetermined electric power (for example, the request electric power of the electric power reception device 4) or less. The electric power transmission side control device 9 repeatedly continues the acquisition of the mutual inductance Lm and the coupling coefficient k with the secondary side coil 15a and the primary side coil 8a with which the pairing is established and the efficiency of electric power transmission, for example, in a period from the time t4 to a time t5.

The electric power transmission side control device 9 performs the ramp-down control when the coupling coefficient k reaches a value less than the predetermined value (predetermined threshold value) ka, for example, as in the time t5 or thereafter. The electric power transmission side output gradually decreases, for example, toward zero by the ramp-down control.

For example, as in a time t6 or thereafter, after the ramp-down control is ended, the electric power transmission side control device 9 shifts the transmission electric power conversion portion 7 from the electric power transmission control state to the stop state. The electric power reception side control device 17 shifts the electric power reception device 4 from the electric power reception control state to the short-circuit state.

As described above, according to the contactless electric power transmission system 1 of the embodiment, by the ramp-up control and the ramp-down control, the transmission electric power is gradually increased or decreased in accordance with the time elapse, and therefore, it is possible to prevent an increase of a load of an electric power source and the occurrence of an overcurrent. For example, when the secondary side coil 15a approaches or leaves the primary side coil 8a, it is possible to prevent the occurrence of a failure such as an increase of a load due to a frequency decrease or the like in a system electric power source on the electric power transmission side and an electric power supply stoppage caused by overcurrent detection due to hunting of a current.

The electric power transmission side control device 9 can prevent an electric power loss from increasing by performing the ramp-down control and the electric power transmission stoppage when the coupling coefficient k is less than the predetermined value (predetermined threshold value) ka. By performing the ramp-down control and temporary stoppage of electric power transmission when the duration time from the start of the electric power transmission control state is equal to or more than the predetermined first time, the electric power transmission side control device 9 can prevent a failure such as an overcharge on the electric power reception side from occurring. It is possible to perform appropriate electric power transmission in accordance with a request to the vehicle V during traveling or during stopping.

Since the electric power transmission side control device 9 controls the electric power transmission by the coupling coefficient k acquired based on the current detected by the electric power transmission device 2, it is possible to perform appropriate electric power transmission, for example, to each of a plurality of vehicles V having different request electric power.

The electric power transmission side control device 9 can acquire the information relating to the electric power transmission newly at each predetermined first time and can perform appropriate electric power transmission in accordance with the request electric power of each vehicle V.

Since the electric power transmission side control device 9 controls the transmission electric power by the duty ratio or the phase shift amount, it is possible to quickly control the transmission electric power even when the electric power reception device 4 moves relative to the electric power transmission device 2.

### Modification Example

The above embodiment is described using an example in which the communication system M constitutes an electronic toll collection system; however, the embodiment is not limited thereto. For example, the communication system M may be a system that simply communicates with the in-vehicle communication device 5 prior to electric power transmission by the electric power transmission device 2 in the electric power transmission zone.

The above embodiment is described using an example in which transmission and reception of the key information and information of the request electric power, the request frequency, and the like of electric power transmission are performed by electric power transmission between the electric power transmission device 2 and the electric power reception device 4; however, the embodiment is not limited thereto. For example, each of the electric power transmission device 2 and the electric power reception device 4 may include a communicator that performs a wireless communication with each other and may perform transmission and reception of the information via the communicators.

In the embodiment described above, for example, in the case of a hybrid vehicle that is driven by using the electric power storage device 11 and an internal combustion engine as power sources or the like, the contactless electric power transmission system 1 may include a storage electric power voltage conversion portion that converts input-output electric power of the electric power storage device 11.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A contactless electric power transmission system comprising:
an electric power transmission side coil that transmits electric power to an electric power reception side coil in a contactless manner;
an electric power transmission side electric power conversion portion that is connected to the electric power transmission side coil and converts electric power supplied from an electric power source; and
an electric power transmission side control device that controls an operation of the electric power transmission side electric power conversion portion,
wherein the electric power transmission side control device changes transmission electric power in a decreasing tendency in accordance with a time elapse until electric power transmission stoppage at a time of electric power transmission by the electric power transmission side coil.

2. The contactless electric power transmission system according to claim 1,
wherein the electric power transmission side control device changes the transmission electric power in the decreasing tendency when a coupling degree between the electric power transmission side coil and the electric power reception side coil is less than a predetermined degree or when an electric power transmission duration time by the electric power transmission side coil is equal to or more than a predetermined time at the time of the electric power transmission by the electric power transmission side coil.

3. The contactless electric power transmission system according to claim 2, comprising:
a current sensor that detects a current which flows through the electric power transmission side coil,
wherein the electric power transmission side control device acquires the coupling degree based on a detection value of the current output from the current sensor.

4. The contactless electric power transmission system according to claim 2,
wherein the electric power transmission side control device shifts the electric power transmission side electric power conversion portion to a reception standby state in which information relating to the electric power transmission is received from the electric power reception side coil after the electric power transmission stoppage when the electric power transmission duration time reaches the predetermined time or more.

5. The contactless electric power transmission system according to claim 1,
wherein the electric power transmission side electric power conversion portion comprises a plurality of switching elements that are connected to the electric power transmission side coil, and
the electric power transmission side control device controls the transmission electric power by a duty ratio or a phase shift amount of a signal that commands an operation of the plurality of switching elements.

6. The contactless electric power transmission system according to claim 2,
wherein the electric power transmission side electric power conversion portion comprises a plurality of switching elements that are connected to the electric power transmission side coil, and
the electric power transmission side control device controls the transmission electric power by a duty ratio or a phase shift amount of a signal that commands an operation of the plurality of switching elements.

7. The contactless electric power transmission system according to claim 3,
wherein the electric power transmission side electric power conversion portion comprises a plurality of switching elements that are connected to the electric power transmission side coil, and
the electric power transmission side control device controls the transmission electric power by a duty ratio or a phase shift amount of a signal that commands an operation of the plurality of switching elements.

8. The contactless electric power transmission system according to claim 4,
wherein the electric power transmission side electric power conversion portion comprises a plurality of switching elements that are connected to the electric power transmission side coil, and
the electric power transmission side control device controls the transmission electric power by a duty ratio or a phase shift amount of a signal that commands an operation of the plurality of switching elements.

9. The contactless electric power transmission system according to claim 4, comprising:
the electric power reception side coil;
an electric power reception side electric power conversion portion that is connected to the electric power reception side coil; and
an electric power reception side control device that controls an operation of the electric power reception side electric power conversion portion,
wherein the electric power reception side control device
shifts the electric power reception side electric power conversion portion to a transmission state in which the information relating to the electric power transmission is transmitted from the electric power reception side coil to the electric power transmission side coil when an electric power reception duration time reaches a predetermined time or more at a time of electric power reception by the electric power reception side coil, and
shifts the electric power reception side electric power conversion portion from the transmission state to an electric power reception standby state of electric power after the information relating to the electric power transmission is transmitted.
